(19) United States
(12) Patent Application Publication
(10) Pub. No.: US 2026/0004005 A1
(43) Pub. Date: Jan. 1, 2026

(54) TRUST LEVEL MAPPING IN SYSTEMS USING MULTIPLE ROOTS OF TRUST

(71) Applicant: Advanced Micro Devices, Inc., Santa Clara, CA (US)

(72) Inventors: Mohit Arora, Austin, TX (US); Mihir S. Doctor, Santa Clara, CA (US); Robert Landon Pelt, Austin, TX (US); Alexander J. Branover, Chestnut Hill, MA (US); Sudhir Ganesh Mathane, Leander, TX (US)

(73) Assignee: Advanced Micro Devices, Inc., Santa Clara, CA (US)

(21) Appl. No.: 18/758,257

(22) Filed: Jun. 28, 2024

(51) Int. Cl. G06F 21/72; G06F 21/60

(52) U.S. Cl. CPC G06F 21/72; G06F 21/604

(57) ABSTRACT

A device includes a plurality of chiplets. At least one pair of chiplets of the plurality of chiplets is coupled to one another. Each chiplet of the plurality of chiplets includes a Root-of-Trust (RoT) circuit and a trust level mapping circuit. For each chiplet of the plurality of chiplets, the trust level mapping circuit of the chiplet is configured to modify trust levels of transactions received from a different chiplet of the plurality of chiplets.

### TECHNICAL FIELD

This disclosure relates to electronic system security and, more particularly, to a Root of Trust framework for an electronic system that uses multiple Roots of Trust.

### BACKGROUND

Many electronic systems are built by combining different subsystems that interact with one another. As an example, consider an electronic system built using multiple chiplets. Chiplet technology facilitates the creation of larger and more reliable devices. While providing many benefits, electronic systems with multiple, different subsystems also pose security challenges.

As an example, in a system with multiple, different chiplets, a security vulnerability of any one of the chiplets may result in a system-wide security vulnerability. For example, if any one of the chiplets included in a System-in-Package (SiP) is vulnerable to a malicious attack, a modification, or other type of security breach, whether during design, assembly, test, or at runtime (e.g., during normal operation), the entire SiP and/or other system in which the SiP is included may be compromised.

Further complicating matters, often one or more of the chiplets included in a SiP are obtained from third-party providers. The SiP designer or assembler may lack detailed knowledge of the inner-workings and/or security practices implemented in a third-party chiplet making integration of the chiplet into the larger security framework of the SiP difficult and potentially error prone.

### SUMMARY

In one or more embodiments, a device includes a plurality of chiplets. At least one pair of chiplets of the plurality of chiplets is coupled to one another. Each chiplet of the plurality of chiplets includes a Root-of-Trust (RoT) circuit and a trust level mapping circuit. For each chiplet of the plurality of chiplets, the trust level mapping circuit of the chiplet is configured to modify trust levels of transactions received from a different chiplet of the plurality of chiplets.

In one or more embodiments, a device includes a first chiplet including a first Root-of-Trust (RoT) circuit and a first trust level mapping circuit. The device includes a second chiplet coupled to the first chiplet. The second chiplet includes a second RoT circuit and a second trust level mapping circuit. The first trust level mapping circuit is configured to modify trust levels of transactions received from the second chiplet. The second trust level mapping circuit is configured to modify trust levels of transactions received from the first chiplet.

In one or more embodiments, a method of transaction processing for a device having a plurality of chiplets includes receiving a transaction in a first chiplet of the device. The transaction originates from a second chiplet of the device. The first chiplet is coupled to the second chiplet. The method includes selecting, using a trust level mapping circuit of the first chiplet, a local trust level for the transaction that is local to the first chiplet. The selecting is based on a trust level included in the transaction and the second chiplet being a source chiplet of the transaction. The method includes generating, using the trust level mapping circuit of the first chiplet, a modified transaction by replacing the trust level in the transaction with the local trust level. The method includes handling the modified transaction within the first chiplet by applying a security policy of the first chiplet to the modified transaction based on the local trust level.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates a device including a plurality of subsystems in accordance with one or more embodiments of the disclosed technology.

FIG. 2 illustrates certain operative features of Root-of-Trust (RoT) circuits of the device of FIG. 1 in accordance with one or more embodiments of the disclosed technology.

FIG. 3 illustrates certain operative features of the trust level mapping circuits of the device of FIG. 1 in accordance with one or more embodiments of the disclosed technology.

FIG. 4 illustrates an architecture for a trust level mapping circuit in accordance with one or more embodiments of the disclosed technology.

FIG. 5 illustrates a method of handling transactions in a device including multiple RoT circuits in accordance with one or more embodiments of the disclosed technology.

FIG. 6 illustrates another device including a plurality of subsystems in accordance with one or more embodiments of the disclosed technology.

FIG. 7 illustrates another device including a plurality of subsystems in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to electronic system security and, more particularly, to a Root of Trust (RoT) framework for an electronic system that uses multiple Roots of Trust (RoTs).

Existing RoT frameworks seek to impose security policies by using a primary RoT circuit that has knowledge of each different circuit resource of each subsystem in the electronic system. For example, in the case of a System-in-Package (SiP), a primary chiplet of the SiP includes the primary RoT circuit. In some cases, the primary RoT may be referred to as the “anchor RoT circuit.” The primary RoT circuit is programmed with data identifying each chiplet in the SiP as well as each circuit resource (e.g., circuit function or Intellectual Property core) of each chiplet. Each circuit resource in the SiP is typically hardcoded with an identifier (ID). The primary RoT circuit maps the ID of each circuit resource to a uniform set of trust levels that exist across all of the chiplets in the SiP. This uniform set of trust levels forms the basis upon which different security levels and/or policies are enforced within and among the chiplets.

This approach suffers from several disadvantages. One disadvantage is an increase in complexity of the primary RoT circuit. To assign IDs of circuit resources to trust levels for the entire SiP, the primary RoT circuit must be aware of all conditions and/or Intellectual Property cores of each chiplet and provision for these conditions. This also means that the primary RoT circuit is responsible for managing internal security policies in each individual chiplet. For example, circuit resources of a first chiplet and of a second chiplet assigned to the same trust level have the same privileges within each respective chiplet as well as across all other chiplets of the SiP. Thus, the primary RoT circuit, by virtue of having the responsibility of assigning IDs to trust levels, dictates the security policies not only for transactions that cross a chiplet boundary, but also for transactions that stay wholly within a single chiplet.

Another disadvantage arises where third-party chiplets are incorporated into the SiP. A system designer may not have detailed knowledge of the internal workings of third-party chiplets. As noted, the primary RoT circuit dictates security policies for transactions among chiplets and within chiplets. Each chiplet, however, may be better suited to manage its own security policies at least for those transactions that stay wholly within that chiplet.

Another disadvantage is that any time a design is modified resulting in a change to the chiplet(s) included in the SiP and/or a change in the circuit resources included in the SiP, the entire security framework may require re-evaluation and/or redesign. The assignment of IDs of the various circuit resources of the SiP across the chiplets to trust levels must be re-evaluated and updated if necessary to ensure that security is maintained among chiplets and within chiplets despite the removal and/or addition of circuit resources. As an example, each newly added circuit resource must be assigned to an existing trust level that is applicable to the circuit resource throughout the entire SiP or a new trust level must be created to accommodate the requirements of that circuit resource requiring a re-thinking of the entire trust level hierarchy. The primary RoT circuit must be updated with such information.

In accordance with the inventive arrangements described within this disclosure, a RoT framework is provided that implements trust level mapping across different subsystems of an electronic system. With the RoT framework disclosed herein, each chiplet is responsible for applying security policies to the circuit resources residing within that particular chiplet (e.g., local to that chiplet). That is, each chiplet will include a RoT circuit that handles security among the local circuit resources of that chiplet. Because no single RoT circuit handles security across the entirety of the SiP, the complexity of the RoT circuits, in general, is reduced. Within each chiplet, the local RoT circuit assigns IDs of the circuit resources therein to trust levels that are applicable within that particular chiplet. Each chiplet is often better suited for handling internal security compared to a centralized entity.

In one or more embodiments, each chiplet of the SiP further includes a trust level mapping circuit. The trust level mapping circuit is configured to analyze incoming transactions that originate from other chiplets of the SiP. The trust level mapping circuit is capable of changing the trust level of the incoming transaction to a local trust level to be used for the transaction within the receiving or local chiplet. The trust level mapping circuit may include a trust level map that maps trust levels of received transactions to local trust levels to be used within that chiplet. This means that two circuit resources located in different chiplets having the same initial trust level may be treated differently in terms of security by virtue of remapping the trust levels of transactions emanating from those circuit resources when received in a different chiplet.

In one or more embodiments, a primary RoT circuit of a primary chiplet is responsible for programming each trust level mapping circuit with a trust level map. The particular trust level map programmed into each trust level mapping circuit may be specific to that trust level mapping circuit. In this manner, the primary RoT circuit ensures that security is enforced within the SiP for transactions that cross chiplet boundaries (e.g., move from one chiplet to another) based on the trust level map as opposed to the trust levels implemented within the various source chiplets of transactions that cross chiplet boundaries.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

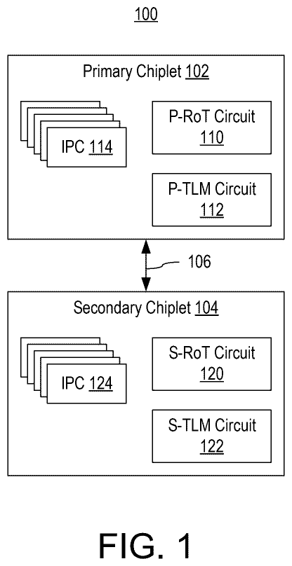

FIG. 1 illustrates a device 100 including a plurality of subsystems in accordance with one or more embodiments of the disclosed technology. In the example of FIG. 1, the subsystems are illustrated as chiplets including a primary chiplet 102 and a secondary chiplet 104. In the example, primary chiplet 102 and secondary chiplet 104 are disposed in the same package. Within this disclosure, the term “chiplet” is synonymous with the term “die.” Thus, device 100 is an example of a SiP, a multi-die integrated circuit (IC), and/or a multi-die System-on-Chip (SoC).

In the example, primary chiplet 102 is coupled to secondary chiplet 104 via a die-to-die interconnect (interconnect) 106. Interconnect 106 may be implemented as any of a variety of die coupling technologies including, but not limited to, die stacking (e.g., 2.5D/3D SiP), an active interposer, a passive interposer, Embedded Multi-die Interconnect Bridge (EMIB), organic substrate-based Die-2-Die (D2D), wafer-level packaging including wafer-level “fab out,” Elevated Fan-out Bridge (EFB), and/or simple organic substrate. In one or more embodiments, communications may be implemented over interconnect 106 in compliance with the Universal Chiplet Interconnect Express (UCIe) specification. It should be appreciated, however, that any of a variety of die-to-die interconnect technologies may be used and any of a variety of communication protocols may be used. In this regard, the inventive arrangements are not intended to be limited to the particular examples provided.

As illustrated, primary chiplet 102 includes a primary Root-of-Trust (P-RoT) circuit 110, a primary trust level mapping (P-TLM) circuit 112, and a plurality of Intellectual Property (IP) cores 114. Secondary chiplet 104 includes a secondary Root-of-Trust (S-RoT) circuit 120, a secondary trust level mapping (S-TLM) circuit 122, and a plurality of IP cores 124. In one or more embodiments, secondary chiplet 104 is created or developed by the same entity that created or developed primary chiplet 102. In one or more other embodiments, secondary chiplet 104 is created or developed by a different entity than the entity that created or developed primary chiplet 102. In that case, for example, secondary chiplet 104 is provided by a third-party provider.

Within this specification, the term “IP core,” also abbreviated as “IPC” in the figures, refers to a portion of circuitry such as a circuit block. An IP core may be expressed or specified as a unit of a circuit design, a unit of logic, a cell, a portion of chip (e.g., IC) layout, or the like. An IP core may be pre-designed and/or reusable. As an example, an IP core may be expressed as a data structure specifying a description of circuitry that performs a particular function. An IP core may be expressed using hardware description language file(s), as a netlist, as a bitstream that programs a programmable IC, or the like. An IP core may be used as a building block within circuit designs adapted for implementation within an IC, a chiplet, and/or a SiP.

In the example of FIG. 1, each chiplet of device 100 includes both a RoT circuit and a TLM circuit. In one or more embodiments, in cases where a selected chiplet of device 100 has a direct connection to more than one other chiplet, the selected chiplet will include one TLM circuit for each other chiplet to which the selected chiplet is directly connected. For purposes of illustration, consider an example where primary chiplet 102 is coupled to secondary chiplet 104 and to an additional secondary chiplet (not shown). In that case, primary chiplet 102 will include one TLM circuit that is reserved or dedicated for processing transactions received from secondary chiplet 104 and another TLM circuit that is reserved or dedicated for processing transactions received from the additional secondary chiplet. That is, each TLM circuit handles transactions that originate from a different source or chiplet in this case.

Within this disclosure, the term “source” refers to the particular IP core and/or chiplet from which a transaction that crosses a chiplet boundary originates. The term “receiving” refers to the particular chiplet or circuit block (e.g., IP core) of a chiplet that receives a transaction that originates from another chiplet. Within this disclosure, for purposes of discussion, the term “local” is used to refer to components and/or subsystems disposed in the same chiplet. For example, P-RoT circuit 110, P-TLM circuit 112, and any/each of IP cores 114 are considered “local” to primary chiplet 102. By comparison, S-RoT circuit 120, S-TLM circuit 122, and any of IP cores 124 are not considered local to primary chiplet 102. In general, the term “local” is also used in connection with the receiving chiplet.

In the example of FIG. 1, primary chiplet 102 and secondary chiplet 104 form a pair of chiplets that are coupled to one another. In other examples including more than two chiplets, each such device includes at least one pair (e.g., one or more pairs of chiplets) that are coupled to one another.

It should be appreciated that device 100 of FIG. 1 is provided for purposes of illustration only. A device having multiple chiplets may include additional chiplets and/or subsystems. In one or more embodiments, device 100 may include one or more memory chiplets. The memory chiplet(s) may be implemented as Double Data Rate, Synchronous Dynamic Random Access Memory (DDR), High-Bandwidth Memory (HBM), and/or other suitable types of memory, for example. For purposes of this disclosure, an HBM stack, though comprised of a plurality of dies, may be considered a chiplet at least with respect to the trust level mapping framework described herein.

In one or more embodiments, the TLM circuits may be implemented as processors capable of executing computer-readable instructions (e.g., program code). In one or more other embodiments, the TLM circuits may be implemented in circuitry, for example, using logic circuitry. Similarly, the RoT circuits may be implemented as processors capable of executing computer-readable instructions. In one or more other embodiments, the RoT circuits may be implemented in circuitry using, for example, logic circuitry. The logic circuitry may be hardwired circuitry, programmable logic, or any combination thereof.

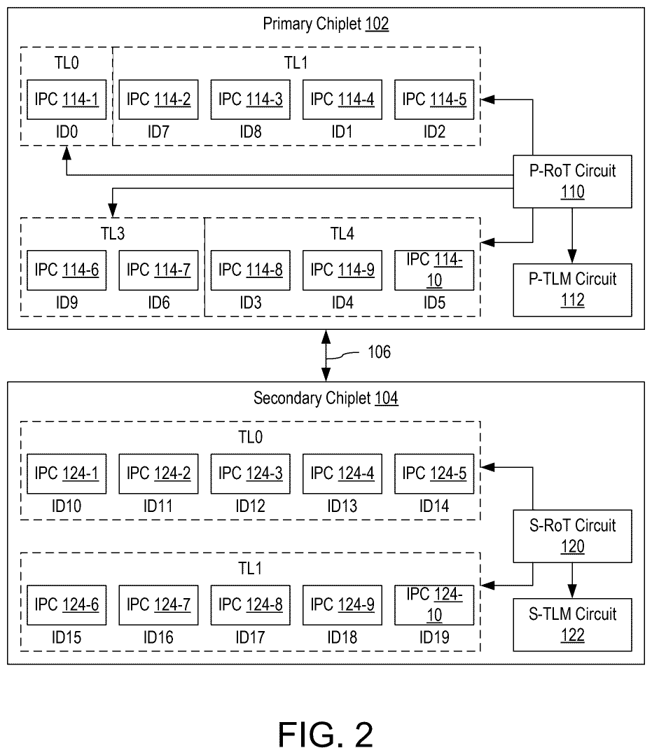

FIG. 2 illustrates certain operative features of the RoT circuits of device 100 of FIG. 1 in accordance with one or more embodiments of the disclosed technology. In the example of FIG. 2, the IP cores of each chiplet are illustrated in greater detail. For purposes of illustration, each chiplet includes 10 different IP cores. It should be appreciated that the number of IP cores included in each chiplet may differ from what is shown.

For example, primary chiplet 102 includes IP cores 114-1, 114-2, 114-3, 114-4, 114-5, 114-6, 114-7, 114-8, 114-9, and 114-10. Secondary chiplet 104 includes IP cores 124-1, 124-2, 124-3, 124-4, 124-5, 124-6, 124-7, 124-8, 124-9, and 124-10. As illustrated, the IP cores 114 and 124 have been assigned identifiers (IDs). In one or more embodiments, each IP core 114 and 124 may be hardcoded with a unique ID.

Further, each of IP cores 114 and 124 is assigned to a particular trust level by the RoT circuit local to the respective IP core. For example, P-RoT circuit 110 assigns IP cores 114 to the different trust levels shown as TL0, TL1, TL3, and TL4 within primary chiplet 102. S-RoT circuit 120 assigns IP cores 124 to the different trust levels shown as TL0 and TL1 within secondary chiplet 104. In this regard, each RoT circuit controls the trust levels and security within its own chiplet. P-RoT circuit 110 controls the security implementation within primary chiplet 102 by assigning IDs of IP cores 114 therein to trust levels. Similarly, S-RoT circuit 120 controls the security implementation within secondary chiplet 104 by assigning IDs of IP cores 124 therein to trust levels.

In the case where a transaction from an IP core 114 and/or IP core 124 leaves a chiplet, e.g., the source chiplet, and is received by another chiplet, e.g., the receiving chiplet, the TLM circuit of the receiving chiplet is capable of mapping the trust level of the transaction to a local trust level of the receiving chiplet. The local trust level is then used for the transaction within the receiving chiplet. For purposes of illustration, consider an example in which IP core 114-6 initiates a transaction to secondary chiplet 104. The trust level of the transaction will be the trust level of the source of the transaction (e.g., IP core 114-6 which is TL3). In that case, S-TLM circuit 122 is capable of detecting the trust level of the transaction from IP core 114-6 as TL3.

The original trust level of the transaction may be referred to as the source trust level. The source trust level is operative within the source chiplet (e.g., primary chiplet 102 in this case). S-TLM circuit 122 is capable of mapping the source trust level TL3 of the transaction to a different trust level called the local trust level. S-TLM circuit 122 replaces the source trust level of TL3 of the transaction with the local trust level. In terms of applying a security policy to the received transaction within secondary chiplet 104, the local trust level is used for the transaction as opposed to the source trust level. S-TLM circuit 122 may release the transaction to a recipient circuit block within secondary chiplet 104 so long as the security policy applicable to the local trust level permits such action.

Similarly, consider an example in which IP core 124-6 initiates a transaction to primary chiplet 102. The trust level of the transaction will be the trust level of the source of the transaction (e.g., IP core 124-6 which is TL1). In that case, P-TLM circuit 112 is capable of detecting the source trust level of the transaction from IP core 124-6 as TL1. The source trust level is operative within the source chiplet (e.g., secondary chiplet 104 in this case). P-TLM circuit 112 is capable of mapping the source trust level TL1 of the transaction to a local trust level. P-TLM circuit 112 replaces the source trust level of TL1 of the transaction with the local trust level. In terms of applying a security policy to the received transaction within primary chiplet 102, the local trust level is used for the transaction. P-TLM circuit 112 may release the transaction to the recipient circuit block within primary chiplet 102 so long as the security policy applicable to the local trust level permits such action.

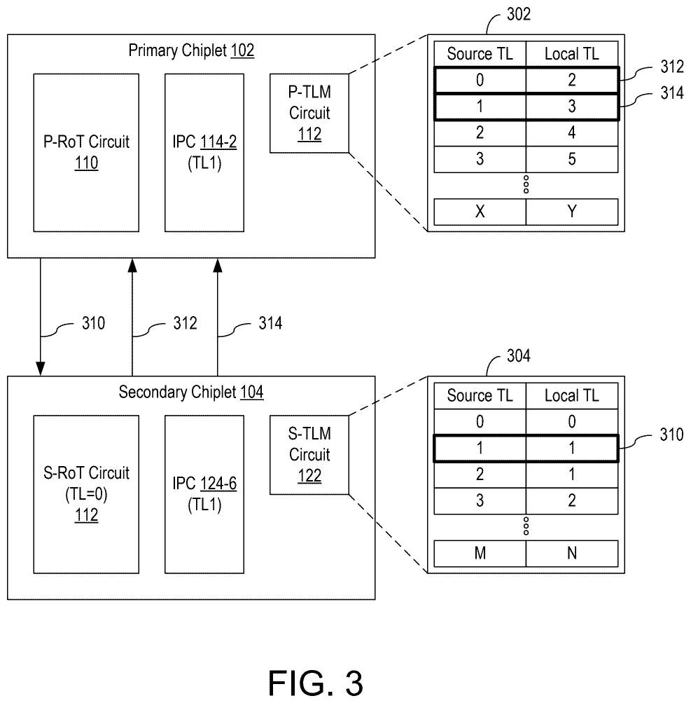

FIG. 3 illustrates certain operative features of the trust level mapping circuits of device 100 of FIG. 1 in accordance with one or more embodiments of the disclosed technology. For purposes of illustration, only IP core 114-2 having a trust level of TL1 is illustrated in primary chiplet 102 while only IP core 124-6 having a trust level of TL1 is illustrated in secondary chiplet 104.

P-TLM circuit 112 implements a trust level map 302. S-TLM circuit 122 implements a trust level map 304. The trust level map implemented by each TLM circuit is specific to the respective TLM circuit. That is, trust level map 302 is specific to P-TLM circuit 112. Trust level map 304 is specific to S-TLM circuit 122. Trust level maps of different TLM circuits may differ from one another. In general, each trust level map specifies a mapping of trust levels for transactions originating in a particular source chiplet to local trust levels used in the receiving chiplet.

For purposes of illustration, consider the three example transactions 310, 312, and 314 occurring between primary chiplet 102 and secondary chiplet 104. Transaction 310 is initiated from primary chiplet 102 to secondary chiplet 104. More particularly, in this example, IP core 114-2 initiates transaction 310 and is considered the source circuit block. Transaction 310 will have a same trust level as the source circuit block. As IP core 114-2 has a trust level of TL1, transaction 310 has a trust level of TL1 (e.g., a source trust level of TL1).

S-TLM circuit 122 receives transaction 310. S-TLM circuit 122 is capable of detecting the source trust level of TL1 in transaction 310. In the example, S-TLM circuit 122 indexes into the second row of trust level map 304 to the entry “1” in the “Source TL” column, which corresponds to source trust level TL1, and selects the corresponding local trust level of TL1. That is, S-TLM circuit 122 selects the entry “1” from the same row under the “Local TL” column. In this example, S-TLM circuit 122 replaces the source trust level of TL1 with the local trust level of TL1 in transaction 312. In this example, while transaction 310 is modified by replacing the source trust level with the local trust level, the two trust levels happen to be the same.

Transaction 312 is initiated from secondary chiplet 104 to primary chiplet 102. More particularly, in this example, S-RoT circuit 112 initiates transaction 312 and is considered the source circuit block. Transaction 312 has the same trust level as the source circuit block. As S-RoT circuit 112 has a trust level of TL0, transaction 312 has a trust level of TL0 (e.g., a source trust level of TL0).

P-TLM circuit 112 receives transaction 312. P-TLM circuit 112 is capable of detecting the source trust level of TL0 in transaction 312. In the example, P-TLM circuit 112 indexes into row 1 of trust level map 302 to the entry “0” in the “Source TL” column, which corresponds to the source trust level TL0, and selects the corresponding local trust level of TL2. That is, P-TLM circuit 112 selects the entry “2” from the same row under the “Local TL” column. In this example, P-TLM circuit 112 replaces the source trust level of TL0 with the local trust level of TL2 in transaction 312. Transaction 312 is handled within primary chiplet 102 as a transaction having a trust level of TL2 as opposed to TL0. This example illustrates that while S-RoT circuit 112 enjoys the highest level of trust for operation within secondary chiplet 104, S-RoT circuit 112 does not enjoy the same trust level in primary chiplet 102.

Transaction 314 is initiated from secondary chiplet 104 to primary chiplet 102. More particularly, in this example, IP core 124-6 initiates transaction 314 and is considered the source circuit block. Transaction 314 has the same trust level as the source circuit block. As IP core 124-6 has a trust level of TL1, transaction 314 has a trust level of TL1 (e.g., a source trust level of TL1).

P-TLM circuit 112 receives transaction 314. P-TLM circuit 112 is capable of detecting the source trust level of TL1 in transaction 314. In the example, P-TLM circuit 112 indexes into row 2 of trust level map 302 to the entry “1” in the “Source TL” column, which corresponds to the source trust level TL1, and selects the corresponding local trust level of TL3. That is, P-TLM circuit 112 selects the entry “3” from the same row under the “Local TL” column. In this example, P-TLM circuit 112 replaces the source trust level of TL1 with the local trust level of TL3 in transaction 314. Transaction 314 is handled within primary chiplet 102 as a transaction having a trust level of TL3 as opposed to TL1.

Because P-RoT circuit 110 is not tasked with assigning IDs of each IP core in each chiplet to trust levels, this task is left to the RoT circuit in each respective chiplet. Device 100 may be expanded through addition of further circuit blocks and/or chiplets by updating the trust level maps of the TLM circuits as needed. That is, the P-RoT circuit 110 need only be updated to handle changes in trust level mapping for transactions that cross chiplet boundaries. Security policies may be more readily expanded despite the addition of further circuit blocks and/or chiplets. The primary chiplet, for example, remains agnostic to trust level handling within the other chiplets. P-RoT circuit 110 is relieved from dealing with the internal security intricacies of the secondary chiplets, which leads to a less complex P-RoT circuit design.

The inventive arrangements also provide flexibility in that any secondary chiplets may be tested without dependency on the primary chiplet particularly in cases where the primary chiplet is not yet available for testing (e.g., is still under development). As such, the suitability of other chiplets for inclusion in the device may be fully evaluated despite the primary chiplet not yet being available for testing and unavailable for interacting with the secondary chiplet(s). Secondary chiplets may be validated for purposes of inclusion in a device without having to couple the secondary chiplet(s) to the primary chiplet.

Each chiplet, whether or not provided by a third-party provider, may be configured as to how to handle in-coming transactions and what types of incoming transactions are allowed by programming/mapping the trust levels for incoming transactions. The RoT circuit in each respective chiplet may be provided with un-disputed access to all of the local resources (e.g., circuit blocks) while enforcing any restrictions for transactions that cross a chiplet boundary to enter the chiplet.

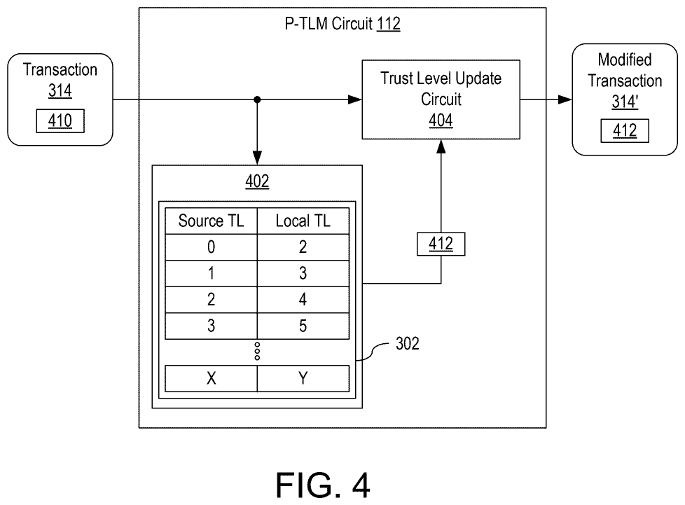

FIG. 4 illustrates an architecture for a trust level mapping circuit in accordance with one or more embodiments of the disclosed technology. For purposes of illustration, FIG. 4 illustrates an example architecture for P-TLM circuit 112. The architecture illustrated in FIG. 4 may be used to implement any TLM circuit implemented in device 100. As noted, the particular data stored as the trust level map may differ from one TLM circuit to another and is specific to each TLM circuit.

In the example of FIG. 4, P-TLM circuit 112 includes a mapping circuit 402 that stores trust level map 302 and a trust level update circuit 404. Mapping circuit 402 and trust level update circuit 404 may be implemented in circuitry, e.g., logic. In the example, mapping circuit 402 may be implemented as a memory, one or more registers capable of storing data as described herein, a lookup-table, and/or other circuitry including logic that maps a source trust level to a local trust level.

In the example of FIG. 4, P-TLM circuit 112 is configured to receive transactions from a particular source chiplet which is secondary chiplet 104 in this example. As illustrated, transaction 314 is directed to mapping circuit 402 and to trust level update circuit 404. As received, transaction 314 includes a source trust level 410 (e.g., TL1). Mapping circuit 402 is capable of detecting source trust level 410 in transaction 314. Trust level 410, for example, may be specified at a known location such as within a header of transaction 314. In one or more embodiments, mapping circuit 402 is capable of extracting source trust level 410 and indexing into trust level map 302 to locate the correct row by matching source trust level 410 with a value in the column Source TL.

In one or more embodiments, mapping circuit 402 uses the extracted source trust level as an address to initiate a read of trust level map 302. Mapping circuit 402, in response to detecting an entry in trust level map 302 that matches the source trust level, outputs the local trust level of the matched entry to trust level update circuit 404. In this example, as discussed in connection with FIG. 3, mapping circuit 402 outputs a local trust level 412, e.g., “3,” to trust level update circuit 404.

Trust level update circuit 404 is capable of replacing, or overwriting, source trust level 410 in transaction 314 with local trust level 412 obtained from trust level map 302. Trust level update circuit 404 replaces source trust level 410 with local trust level 412 resulting in the generation of a modified version of transaction 314 illustrated as modified transaction 314′. As illustrated in FIG. 4, modified transaction 314′ includes local trust level 412 in place of source trust level 410.

In one or more embodiments, in the case where no Source TL entry in trust level map 302 matches the source trust level of transaction 314, local trust level 410 may be output from mapping circuit 402 with a default or predetermined value. Mapping circuit 402 may include logic that outputs a default value in response to a mismatch, e.g., a case where no entry in trust level map 302 matches or corresponds to the source trust level of the received transaction. Use of a default trust level in such cases prevents potential attacks or other unanticipated transactions not accounted for in the trust level map from gaining access to sensitive systems in the local chiplet by assigning a default and lower level of trust to such transactions. For example, the default value may be the lowest level of trust (e.g., the most untrusted level). Trust level update circuit 404 may replace the source trust level 410 of transaction 314 with the local trust level 412 having a default value (e.g., a value other than one specified in trust level map 302).

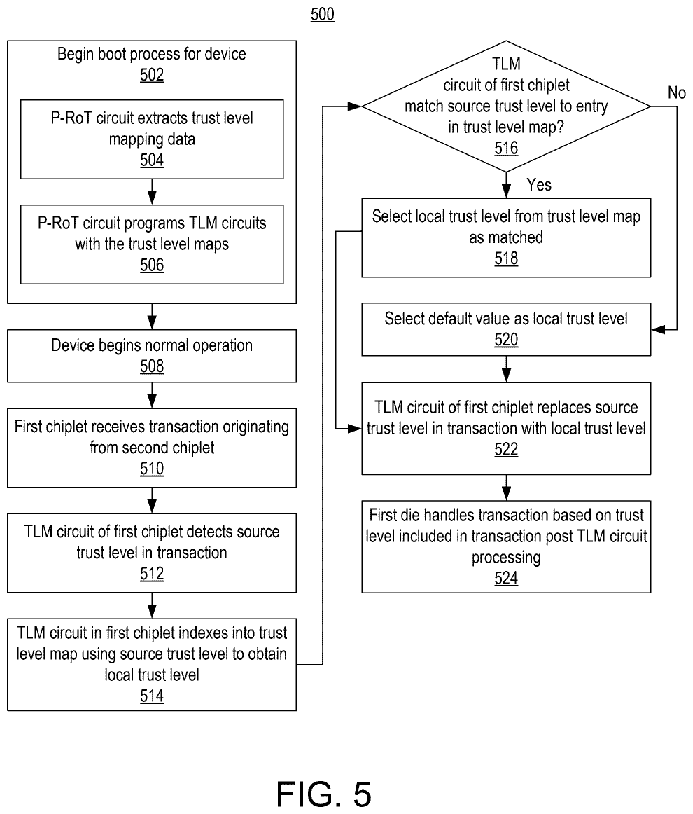

FIG. 5 illustrates a method 500 of handling transactions in a device including multiple RoT circuits in accordance with one or more embodiments of the disclosed technology. Method 500 may be performed by a device as described herein in connection with FIGS. 1, 2, 3, and 4.

Method 500 may begin in block 502 where the device 100 begins a boot process. In block 502, for example, P-RoT circuit 110 is capable of fetching a boot image from a trusted source such as a non-volatile memory accessible by device 100. The non-volatile memory, for example, may be disposed on a same circuit board as device 100 and coupled thereto such that device 100 may fetch the boot image stored in the non-volatile memory. The boot image includes trust level mapping data, e.g., each trust level map to be loaded into each respective TLM circuit of device 100.

In block 504, the P-RoT circuit 110 extracts the trust level mapping data, e.g., trust level maps, from the boot image. In block 506, the P-RoT circuit 110 programs each TLM circuit, e.g., each mapping circuit, with the particular trust level map for that respective TLM circuit. Referring to the example of FIG. 2, P-RoT circuit 110 programs P-TLM circuit 112 with trust level map 302 as extracted from the boot image. Similarly, P-RoT circuit 110 programs S-TLM circuit 122 with trust level map 304 as extracted from the boot image.

In one or more embodiments, the RoT circuit of the first chiplet assigns trust levels to IP cores of the first chiplet while the RoT circuit of the second chiplet assigns trust levels to IP cores of the second chiplet. The assignment of trust levels to individual IP cores of the respective chiplets by RoT circuits in each respective chiplet may be performed as part of the boot process.

For purposes of illustration, the terms first, second, etc. may be used herein to describe various elements. These elements should not be limited by these terms, as these terms are only used to distinguish one element from another unless stated otherwise or the context clearly indicates otherwise. For example, the term “first” may refer to one chiplet while the term “second” may refer to a different chiplet. In this context, the term “first” may apply to the primary (secondary) chiplet while the term “secondary” may apply to the secondary (primary) chiplet depending on the context.

In block 508, device 100 may begin normal operation. For example, the boot process, which may include other operations not described herein, may be completed so that device 100 may begin normal operation. In block 510, a first chiplet of device 100 receives a transaction originating from a second chiplet of device 100.

In block 512, the TLM circuit of the first chiplet detects a source trust level in the transaction received from the second chiplet. In block 514, the TLM circuit of the first chiplet indexes into the trust level map stored therein (e.g., within the TLM circuit of the first chiplet) using the source trust level to obtain the local trust level. For example, from the trust level map, the TLM circuit selects a local trust level for the transaction based on the source trust level included in the transaction. As discussed, each trust level map is specific to a TLM circuit and, as such, also specific to a particular source chiplet from which transactions are received.

In block 516, the TLM circuit of the first chiplet detects whether the source trust level of the transaction matches an entry in the trust level map as described in connection with FIG. 4. In response to detecting a match, in block 518, the TLM circuit of the first chiplet selects the local trust level from the matched entry as the local trust level for use in modifying the transaction. In response to detecting that the source trust level of the transaction does not match any entry of the trust level map, e.g., a mismatch is detected, the TLM circuit of the first chiplet selects a default value in block 520 as the local trust level to be used in modifying the transaction.

In block 522, the TLM circuit of the first chiplet replaces the source trust level of the transaction with the local trust level. The modified transaction that includes the source trust level now specifies the appropriate trust level for handling within the first chiplet.

In block 524, the first die handles the transaction therein based on the trust level included in the transaction post TLM circuit processing. That is, the trust level included in the transaction post TLM circuit processing is utilized within the first chiplet for enforcement of any applicable security policies. The modified transaction is handled within the first chiplet by applying a security policy of the first chiplet to the modified transaction based on the local trust level as opposed to the source trust level.

In one or more embodiments, the modified transaction is handled by selectively forwarding the modified transaction to circuitry within the first chiplet based on the security policy of the first chiplet and the trust level of the modified transaction, e.g., post processing by the TLM circuit. For example, in some cases, depending on the internal security policies of the receiving chiplet and the trust level of the modified transaction, the transaction may be discarded (e.g., not forwarded to any other circuits within the receiving chiplet).

It should be appreciated that blocks 510-524 may be performed from the perspective of the first chiplet sending a transaction to the second chiplet such that the TLM circuit of the second chiplet performs the operations described in connection with blocks 512-522.

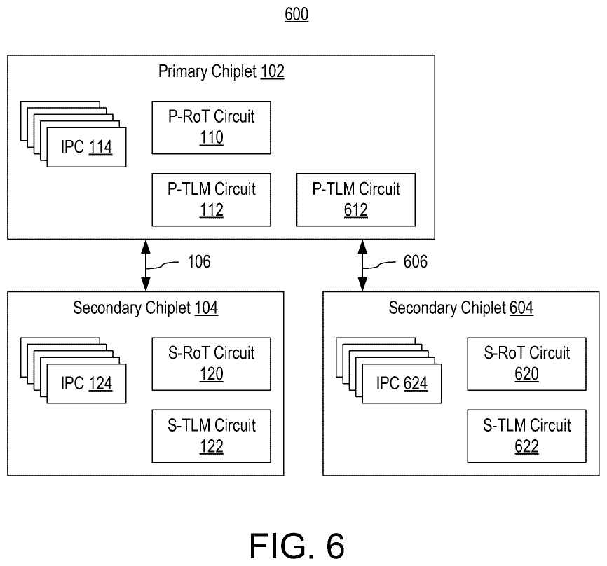

FIG. 6 illustrates a device 600 including a plurality of subsystems in accordance with one or more embodiments of the disclosed technology. The example of FIG. 6 includes more than two different chiplets included in a same package.

As illustrated, device 600 incudes primary chiplet 102 implemented substantially as described in connection with FIG. 1. In the example of FIG. 6, primary chiplet 102 includes an additional P-TLM circuit 612. Device 600 includes secondary chiplet 104 coupled to primary chiplet 102 as described herein in connection with FIG. 1. Device 600 also includes an additional secondary chiplet 604 that is coupled to primary chiplet 102 via interconnect 606. Additional secondary chiplet 604 includes an S-RoT circuit 620, an S-TLM circuit 622, and one or more IP cores 624.

In the example, P-TLM circuit 612 operates substantially the same as P-TLM circuit 112 with the exception that P-TLM circuit 612 operates on transactions received over interconnect 606 from secondary chiplet 604. S-RoT circuit 620 operates substantially the same as S-RoT circuit 120 albeith with respect to assigning IDs of IP cores 624 to trust levels. Similarly, S-TLM circuit 622 operates substantially the same as S-TLM circuit 122. In the case of FIG. 6, S-TLM circuit 622 operates on transactions received from primary chiplet 102.

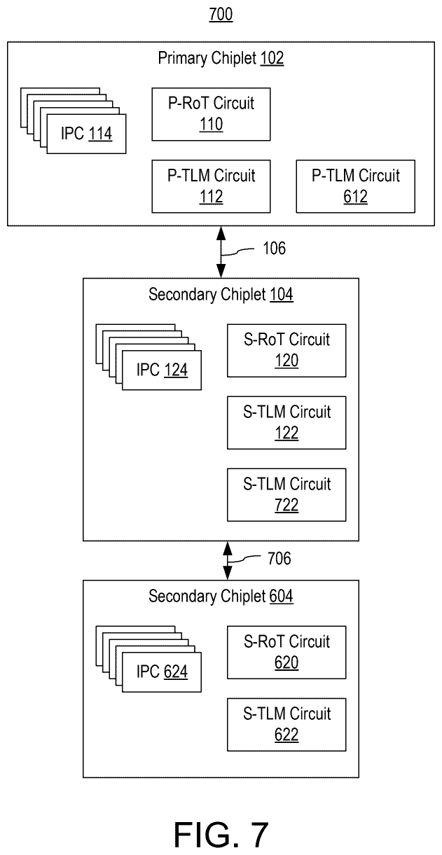

FIG. 7 illustrates a device 700 including a plurality of subsystems in accordance with one or more embodiments of the disclosed technology. The example of FIG. 7 is substantially similar to the example of FIG. 6. In the case of FIG. 7, secondary chiplet 104 and secondary chiplet 604 communicate with one another via interconnect 706. Secondary chiplet 604 does not communicate directly with primary chiplet 102. In the example, secondary chiplet 104 includes a further TLM circuit shown as S-TLM circuit 722 which operates on transactions received over interconnect 706 from secondary chiplet 604. In the example, S-TLM circuit 622 operates on transactions received over interconnect 706 from secondary chiplet 104.

In each of the examples of FIGS. 6 and 7, the TLM circuits may be programmed by P-RoT circuit 110 with a TLM circuit specific trust level map. Each trust level map is specific to the particular chiplet in which that TLM circuit is disposed and is specific to the source of transactions being received (e.g., as such the interconnect in the case where the interconnect connects two chiplets).

In the example of FIG. 7, any communication between primary chiplet 102 and secondary chiplet 604 may be implemented through secondary chiplet 104. In that case, transactions originating from primary chiplet 102 that are directed to secondary chiplet 604 may undergo trust level re-mapping by S-TLM circuit 122 within secondary chiplet 104 and undergo further trust level re-mapping by S-TLM circuit 622 as received in secondary chiplet 604. Similarly, transactions originating from secondary chiplet 604 that are directed to primary chiplet 102 may undergo trust level re-mapping by S-TLM circuit 722 within secondary chiplet 104 and undergo further trust level re-mapping by P-TLM circuit 112 as received in primary chiplet 102.

It should be appreciated that further arrangements of chiplets within a device may be implemented that support any of a variety and/or combination of connections illustrated within this disclosure. Further, the examples described herein may be used for any of a variety of different devices and/or chiplets. For example, the trust level mapping frameworks described herein may be included and/or used in Graphics Processing Units (GPUs) whether such GPUs are implemented as multi-chiplet devices or implemented as one or more chiplets included in a SiP; included in a device that implements a processor (e.g., a data processing system such as a computer in single package); a device that includes chiplets of different varieties such as memory chiplets (e.g., high-bandwidth memory and/or DRAM or other RAM), programmable circuitry (e.g., programmable logic), CPU chiplet(s), GPU chiplet(s), and/or processor array chiplet(s).

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the disclosed technology have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a plurality of chiplets, wherein at least one pair of chiplets of the plurality of chiplets is coupled to one another;
wherein each chiplet of the plurality of chiplets includes a Root-of-Trust (RoT) circuit and a trust level mapping circuit; and
wherein, for each chiplet of the plurality of chiplets, the trust level mapping circuit of the chiplet is configured to modify trust levels of transactions received from a different chiplet of the plurality of chiplets.

2. The device of claim 1, wherein each trust level mapping circuit includes a trust level map, and wherein each trust level map specifies a mapping of trust levels of transactions originating from a source chiplet to local trust levels of a local chiplet receiving the transactions.

3. The device of claim 2, wherein each trust level mapping circuit further comprises:
a mapping circuit configured to receive a selected transaction from the source chiplet and, in response to receiving the selected transaction, select a local trust level for the selected transaction based on the trust level map; and
a trust level update circuit configured to update the selected transaction by replacing a trust level of the selected transaction with the local trust level for the selected transaction.

4. The device of claim 2, wherein a RoT circuit of a first chiplet of the plurality of chiplets is configured to program each trust level mapping circuit with the trust level map specific to the trust level mapping circuit.

5. A device, comprising:
a first chiplet including a first Root-of-Trust (RoT) circuit and a first trust level mapping circuit; and
a second chiplet coupled to the first chiplet, wherein the second chiplet includes a second RoT circuit and a second trust level mapping circuit;
wherein the first trust level mapping circuit is configured to modify trust levels of transactions received from the second chiplet; and
wherein the second trust level mapping circuit is configured to selectively modify trust levels of transactions received from the first chiplet.

6. The device of claim 5, wherein each trust level mapping circuit includes a trust level map, and wherein each trust level map specifies a mapping of trust levels of transactions originating from a source chiplet to local trust levels of a local chiplet receiving the transactions.

7. The device of claim 6, wherein each trust level mapping circuit further comprises:
a mapping circuit configured to receive a selected transaction from the source chiplet and, in response to receiving the selected transaction, select a local trust level for the selected transaction based on the trust level map; and
a trust level update circuit configured to update the selected transaction by replacing a trust level of the selected transaction with the local trust level for the selected transaction.

8. The device of claim 7, wherein the local trust level is a default trust level selected in response to detecting that the trust level of the selected transaction does not match any entry in the trust level map.

9. The device of claim 7, wherein the local trust level is selected from an entry in the trust level map that matches the trust level of the selected transaction.

10. The device of claim 5, wherein:
the first trust level mapping circuit comprises a first trust level map specifying a mapping of trust levels of transactions received from the second chiplet to local trust levels for the first chiplet; and
the second trust level mapping circuit comprises a second trust level map specifying a mapping of trust levels of transactions received from the first chiplet to local trust levels for the second chiplet.

11. The device of claim 10, wherein the first trust level map and the second trust level map are different.

12. The device of claim 10, wherein the first trust level map is specific to the first trust level mapping circuit and the second trust level map is specific to the second trust level mapping circuit.

13. The device of claim 10, wherein the first RoT circuit is configured to program the first trust level map into the first trust level mapping circuit and to program the second trust level map into the second trust level mapping circuit.

14. The device of claim 5, wherein:
the first RoT circuit is configured to assign trust levels to Intellectual Property cores of the first chiplet; and
the second RoT circuit is configured to assign trust levels to Intellectual Property cores of the second chiplet.

15. A method of transaction processing for a device having a plurality of chiplets, the method comprising:
receiving a transaction in a first chiplet of the device, wherein the transaction originates from a second chiplet of the device, and wherein the first chiplet is coupled to the second chiplet;
selecting, using a trust level mapping circuit of the first chiplet, a local trust level for the transaction that is local to the first chiplet, wherein the selecting is based on a trust level included in the transaction and the second chiplet as a source chiplet of the transaction;
generating, using the trust level mapping circuit of the first chiplet, a modified transaction by replacing the trust level in the transaction with the local trust level; and
handling the modified transaction within the first chiplet by applying a security policy of the first chiplet to the modified transaction based on the local trust level.

16. The method of claim 15, wherein the handling comprises selectively forwarding the modified transaction to circuitry within the first chiplet based on the security policy of the first chiplet and the local trust level of the modified transaction.

17. The method of claim 15, wherein the second chiplet includes a trust level mapping circuit, the method further comprising:
programming the trust level mapping circuit of the first chiplet and the trust level mapping circuit of the second chiplet using a Root-of-Trust (RoT) circuit of either the first chiplet or a RoT circuit of the second chiplet.

18. The method of claim 17, wherein the programming is performed as part of a boot process for the device.

19. The method of claim 15, further comprising:
receiving a further transaction in the second chiplet, wherein the further transaction originates from the first chiplet;
selecting, using a trust level mapping circuit of the second chiplet, a local trust level for the further transaction that is local to the second chiplet, wherein the selecting is based on a trust level specified by the further transaction and the first chiplet as a source chiplet for the further transaction;
generating, using the trust level mapping circuit of the second chiplet, a modified further transaction by replacing the trust level in the further transaction with the local trust level for the further transaction; and
handling the modified transaction within the second chiplet by applying a security policy of the second chiplet to the modified further transaction based on the local trust level of the further transaction.

20. The method of claim 15, further comprising:
assigning, by a Root-of-Trust (RoT) circuit of the first chiplet, trust levels to Intellectual Property cores of the first chiplet; and
assigning, by a RoT circuit of the second chiplet, trust levels to Intellectual Property cores of the second chiplet.
